(19) United States
(12) Patent Application Publication
(10) Pub. No.: US 2025/0372838 A1
(43) Pub. Date: Dec. 4, 2025

(54) BATTERY AND BATTERY PRODUCTION METHOD

(71) Applicant: TOYOTA JIDOSHA KABUSHIKI KAISHA, Toyota-shi, (JP)

(72) Inventor: Hiroshi NAGASE, Nagoya-shi (JP)

(73) Assignee: TOYOTA JIDOSHA KABUSHIKI KAISHA, Toyota-shi, (JP)

(21) Appl. No.: 19/218,858

(22) Filed: May 27, 2025

(30) Foreign Application Priority Data
May 31, 2024 (JP) 2024-089360

(51) Int. Cl. H01M 50/54; H01M 50/536

(52) U.S. Cl. CPC H01M 50/54; H01M 50/536

(57) ABSTRACT

Disclosed is a battery capable of improving connectivity between a terminal and a current collector part while improving structural efficiency around them. The battery of the present disclosure includes an electrode laminate, a current collector part, and a terminal. The electrode laminate is electrically connected to the terminal via the current collector part. The terminal includes a base and a protrusion. The base has a first surface facing the electrode laminate and a second surface opposite the first surface. The protrusion protrudes from the base toward the electrode laminate. The protrusion includes a first protrusion and a second protrusion. The first protrusion has a third surface facing the second protrusion. The second protrusion has a fourth surface facing the first protrusion. The current collector part is in contact with one or both of the first surface and the third surface. The second protrusion is welded to the base.

### FIELD

The present disclosure relates to a battery and a battery production method.

### BACKGROUND

Patent Literature 1 discloses a battery, wherein an electrode laminate and a lid terminal are electrically connected via a current collector part, an exterior body is adhered to an outer periphery of the lid terminal, and the current collector part and the electrode laminate are housed inside the exterior body.

### CITATION LIST

### Patent Literature

[PTL 1] Japanese Unexamined Patent Publication No. 2023-084066

### SUMMARY

### Technical Problem

Conventional batteries have room for improvement in terms of connectivity between the terminal and current collector part while improving structural efficiency around the terminal and current collector part.

### Solution to Problem

The present disclosure provides, as means for achieving the object described above, the following multiple aspects.

### Aspect 1

A battery, comprising an electrode laminate, a current collector part, and a terminal, wherein
the electrode laminate is electrically connected to the terminal via the current collector part,
the terminal comprises a base and a protrusion,
the base has a first surface facing the electrode laminate and a second surface opposite the first surface,
the protrusion protrudes from the base toward the electrode laminate,
the protrusion comprises a first protrusion and a second protrusion,
the first protrusion has a third surface facing the second protrusion,
the second protrusion has a fourth surface facing the first protrusion,
the current collector part is in contact with one or both of the first surface and the third surface, and
the second protrusion is welded to the base.

### Aspect 2

The battery according to Aspect 1, wherein
the base is thicker than the first protrusion and the second protrusion.

### Aspect 3

The battery according to Aspect 1 or 2, wherein
the protrusion comprises a third protrusion and a fourth protrusion.

### Aspect 4

The battery according to Aspect 3, wherein
the base is thicker than the third protrusion and the fourth protrusion.

### Aspect 5

The battery according to Aspect 3 or 4, wherein
one or both of the third protrusion and the fourth protrusion is welded to at least one of the base, the first protrusion, and the second protrusion.

### Aspect 6

The battery according to any one of Aspects 3 to 5, wherein
a planar shape of the base is a rectangle,
the rectangle comprises a first side and a second side facing each other and a third side and a fourth side facing each other,
the first protrusion protrudes from the first side,
the second protrusion protrudes from the second side,
the third protrusion protrudes from the third side, and
the fourth protrusion protrudes from the fourth side.

### Aspect 7

The battery according to any one of Aspects 3 to 6, wherein
the planar shape of the base is an elongated rectangle,
the first protrusion protrudes from one long side of the elongated rectangle,
the second protrusion protrudes from another long side of the elongated rectangle,
the third protrusion protrudes from one short side of the elongated rectangle, and
the fourth protrusion protrudes from another short side of the elongated rectangle.

### Aspect 8

The battery according to Aspect 7, wherein
a lamination direction in the electrode laminate is along the short sides, and
a width direction of the electrode laminate is along the long sides.

### Aspect 9

The battery according to any one of Aspects 1 to 8, wherein
the protrusion protrudes from an outer edge of the base.

### Aspect 10

The battery according to any one of Aspects 1 to 9, wherein
a ratio of a width of the current collector part to an inner width of the base is 0.9 or more.

### Aspect 11

The battery according to any one of Aspects 1 to 10, wherein
a thickness of the base is less than a protrusion length of the protrusion.

### Aspect 12

The battery according to any one of Aspects 1 to 11, wherein
a thickness of the terminal is less than a thickness of the electrode laminate.

### Aspect 13

The battery according to any one of Aspects 1 to 12, wherein
the terminal is connected to a bus bar.

### Aspect 14

The battery according to any one of Aspects 1 to 13, wherein
the current collector is ultrasonically or laser joined to one or both of the first surface and the third surface.

### Aspect 15

The battery according to any one of Aspects 1 to 14, wherein
the first protrusion and the second protrusion each have an insulating layer at an end surface on the electrode laminate side.

### Aspect 16

The battery according to any one of Aspects 1 to 15, wherein
the first protrusion has a fifth surface opposite the third surface,
the second protrusion has a sixth surface opposite the fourth surface,
the electrode laminate and the current collector part are housed in a laminate exterior body, and
the laminate exterior body is adhered to the fifth surface and the sixth surface.

### Aspect 17

A method for the production of the battery according to any one of Aspects 1 to 16, the method comprising:
connecting the current collector to a first metal member, and
welding a second metal member to the first metal member, to which the current collector is connected, wherein
the base and the first protrusion of the terminal are constituted by the first metal member, and
the second protrusion of the terminal is constituted by the second metal member.

### Advantageous Effects of Invention

According to the technology of the present disclosure, structural efficiency around the terminal and current collector part of the battery is easily improved (space is easily reduced), and connection of the terminal and the current collector is easy.

### BRIEF DESCRIPTION OF DRAWINGS

FIG. 1 schematically shows an example of the external configuration of a battery.

FIG. 2 schematically shows an example of the configuration of the cross section taken along line II-II of FIG. 1.

FIG. 3 schematically shows an example of the configuration of the cross section taken along line III-III of FIG. 1.

FIG. 4 schematically shows an example of the configuration of the cross section taken along line IV-IV of FIG. 1.

FIG. 5 schematically shows an example of the external shape of a terminal. The weld is omitted.

FIG. 6 schematically shows an example of the cross section of a terminal.

FIG. 7 schematically shows an example of the cross section of a terminal.

FIG. 8 schematically shows an example of the external shape of a base.

FIG. 9 schematically shows an example of the cross section of a terminal.

FIG. 10 schematically shows an example of the cross section when an insulating layer is provided on part of a terminal.

FIG. 11 schematically shows an example of an adherence state between a terminal and an exterior body. The current collector part and electrode laminate are omitted.

FIG. 12 schematically shows an example of flow of a battery production method.

### DESCRIPTION OF EMBODIMENTS

The embodiments of the battery and the battery production method of the present disclosure will be described below, but the battery and the battery production method of the present disclosure are not limited to the following embodiments.

### 1. Battery

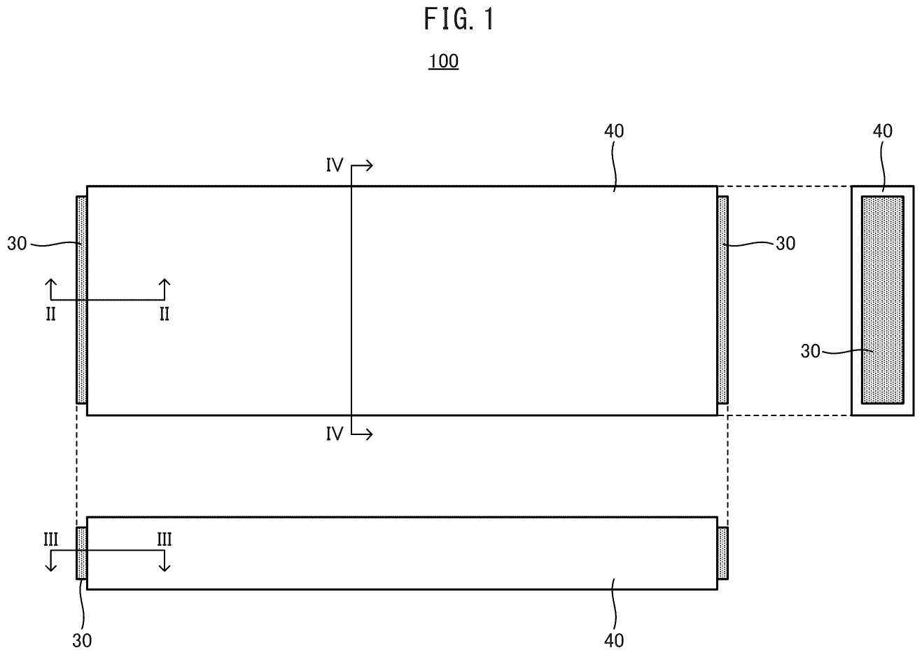

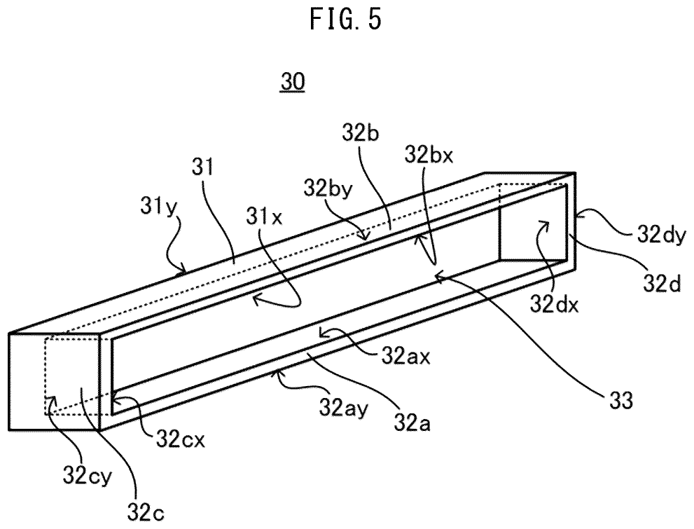

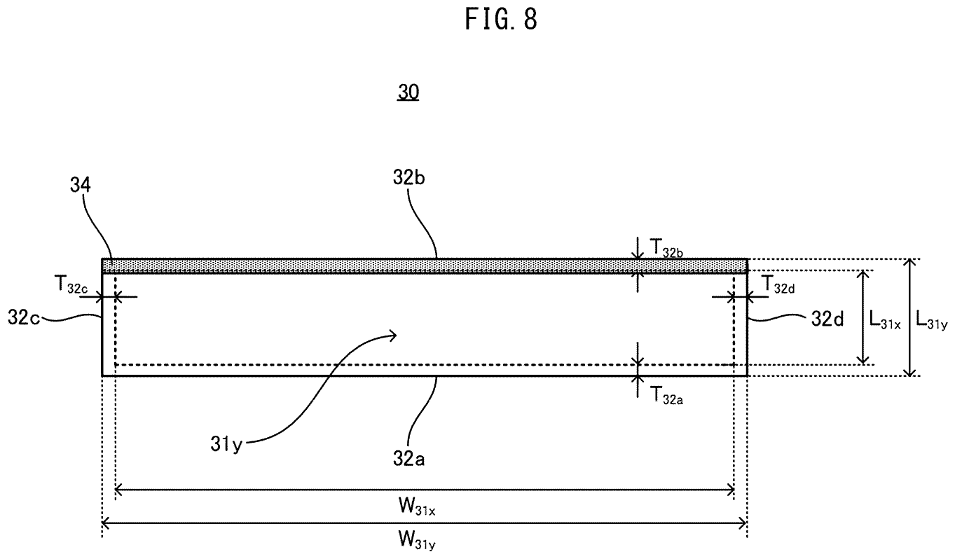

As shown in FIGS. 1 to 8, a battery 100 according to an embodiment comprises an electrode laminate 10, a current collector part 20, and a terminal 30. The electrode laminate 10 is electrically connected to the terminal 30 via the current collector part 20. The terminal 30 comprises a base 31 and a protrusion 32. The base 31 has a first surface 31x facing the electrode laminate 10, and a second surface 31y opposite the first surface 31x. The protrusion 32 protrudes from the base 31 toward the electrode laminate 10. The protrusion 32 comprises a first protrusion 32a and a second protrusion 32b. The first protrusion 32a has a third surface 32ax facing the second protrusion 32b. The second protrusion 32b has a fourth surface 32bx facing the first protrusion 32a. The current collector part 20 is in contact with one or both of the first surface 31x and the third surface 32ax. The second protrusion 32b is welded to the base 31.

### 1.1 Electrode Laminate

The battery 100 supplies the power generated by the electrode laminate 10 to external devices and the like via the current collector part 20 and the terminal 30. Specifically, the electrode laminate 10 functions as a power generating element of the battery 100.

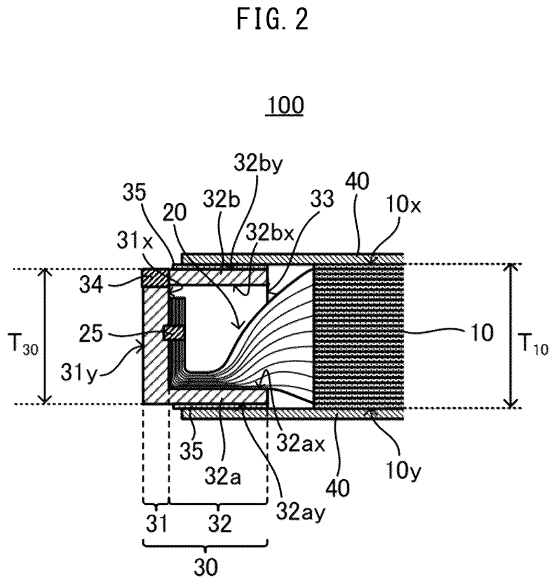

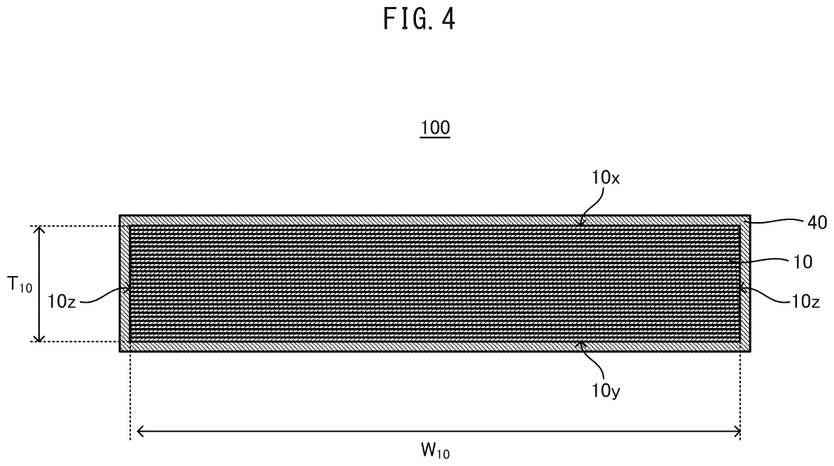

As shown in FIGS. 2 and 4, the electrode laminate 10 may be formed by stacking a plurality of electrode bodies. Each electrode body can comprise, for example, a layer composed of a positive electrode current collector, a positive electrode active material layer, an electrolyte layer, a negative electrode active material layer, and a layer composed of a negative electrode current collector. The positive electrode current collector, the positive electrode active material layer, the electrolyte layer, the negative electrode active material layer, and the negative electrode current collector may be publicly known components. The electrode laminate 10 may contain a solid electrolyte, a liquid electrolyte, or a solid electrolyte and a liquid electrolyte. When the electrode laminate 10 contains at least a solid electrolyte, a battery 100 having excellent mechanical properties, output properties, etc., can easily be obtained. The shape of the lamination surface of the layers constituting the electrode laminate 10 may be, for example, rectangular.

The number of electrode bodies stacked in the electrode laminate 10 is not particularly limited. In the electrode laminate 10, the plurality of electrode bodies may be connected to each other in series or in parallel. The electrode laminate 10 may have a bipolar structure. In the electrode laminate 10, the lamination surfaces of the electrode bodies may be insulated from each other by providing an insulating layer between one electrode body and another electrode body. As shown in FIG. 2, in the battery 100, the plurality of electrode bodies can be electrically connected to each other by the current collector part 20. For example, the plurality of electrode bodies can be electrically connected to each other in parallel by the current collector part 20.

As shown in FIGS. 2 to 4, the electrode laminate 10 may have an end surface 10x at one end in the lamination direction of each of the layers, an end surface 10y at the other end in the lamination direction of each of the layers, and side surfaces 10z each connecting the end surface 10x and the end surface 10y. Each side surface 10z may be formed by the outer edges of the layers constituting the electrode laminate 10. In the electrode laminate 10, the lamination areas of the layers may differ so that the side surfaces 10z may have concavities and convexities or gaps. Each side surface 10z may have a surface along the lamination direction of the layers in the electrode laminate 10. The current collector part 20, which is described later, can protrude from the side surface 10z of the electrode laminate 10 to the terminal 30. The electrode laminate 10 may be, for example, in the shape of a plate or a rectangular parallelepiped as a whole.

As shown in FIGS. 2 and 4, the electrode laminate 10 can have a thickness T₁₀ along the lamination direction. The thickness T₁₀ of the electrode laminate 10 is not particularly limited. The thickness T₁₀ of the electrode laminate 10 may be, for example, 5 mm or more and 100 mm or less, or 10 mm or more and 50 mm or less.

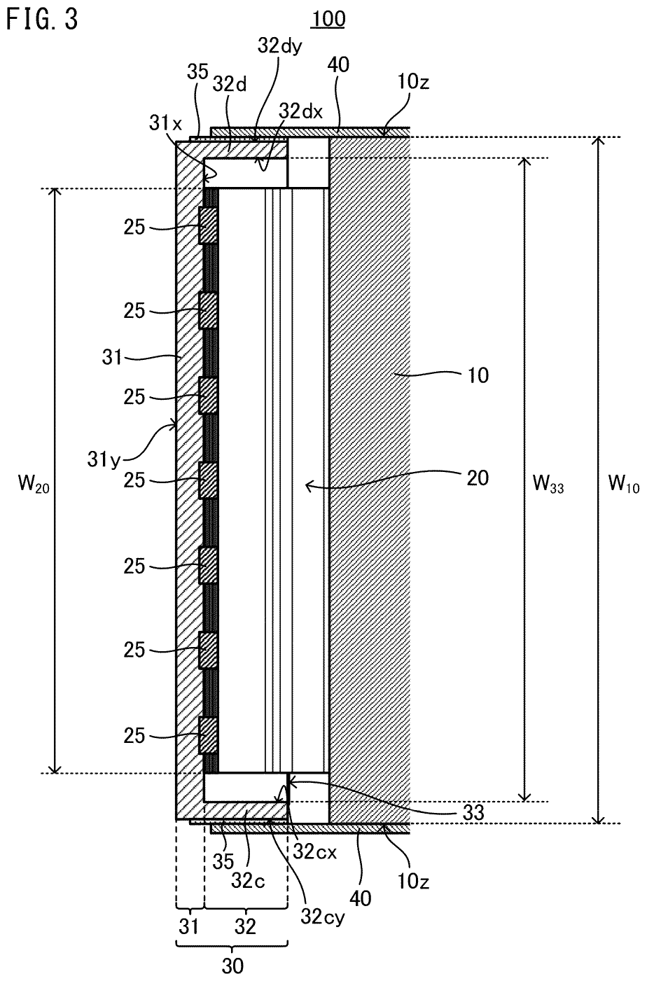

As shown in FIGS. 3 and 4, the electrode laminate 10 can have a width W₁₀ along the lamination surface at the side surface 10z where the current collector part 20 protrudes. The width W₁₀ of the electrode laminate 10 is not particularly limited. The width W₁₀ of the electrode laminate 10 may be, for example, 10 mm or more and 500 mm or less, or 50 mm or more and 200 mm or less.

### 1.2 Current Collector Part

The current collector part 20 protrudes from the electrode laminate 10 toward the terminal 30, and electrically connects the electrode laminate 10 and the terminal 30. More specifically, as shown in FIGS. 2 and 3, a part of the current collector part 20 including the tip on the terminal 30 side may be connected to one or both of the first surface 31x and the third surface 32ax of the terminal 30.

As shown in FIGS. 2 and 3, the current collector part 20 may be, for example, a bundle of a plurality of current collectors protruding from the side surface 10z of the electrode laminate 10 toward the terminal 30. The number of current collectors protruding in the same direction from the electrode laminate 10 is not particularly limited, and may be, for example, 10 to 200, or 30 to 100. In the battery 100, the current collector part 20 may be a bundle of a plurality of positive electrode current collectors, or a bundle of a plurality of negative electrode current collectors.

The current collector constituting the current collector part 20 may be, for example, a metal foil or a metal mesh. From the viewpoint of excellent handling, the current collector part 20 may comprise a plurality of metal foils. Examples of the metal constituting the current collector include Cu, Ni, Cr, Au, Pt, Ag, Al, Fe, Ti, Zn, Co, and stainless steel. The current collector may have some type of coating layer on the surface thereof for the purpose of adjusting the resistance, etc. Furthermore, when the current collector part 20 is composed of a plurality of metal foils, some type of layer may be present between the plurality of metal foils. The thickness of each current collector is not particularly limited. For example, it may be 0.1 μm or more, it may be 1 μm or more, it may be 1 mm or less, and it may be 100 μm or less.

As shown in FIG. 3, the current collector part 20 can have a width W₂₀ in a direction perpendicular to the protrusion direction of the current collector part 20 from the electrode laminate 10 and along the lamination surface of the electrode laminate 10. The width W₂₀ of the current collector part 20 is not particularly limited. The width W₂₀ of the current collector part may be, for example, 5 mm or more and 450 mm or less, or 20 mm or more and 190 mm or less.

### 1.3 Terminal

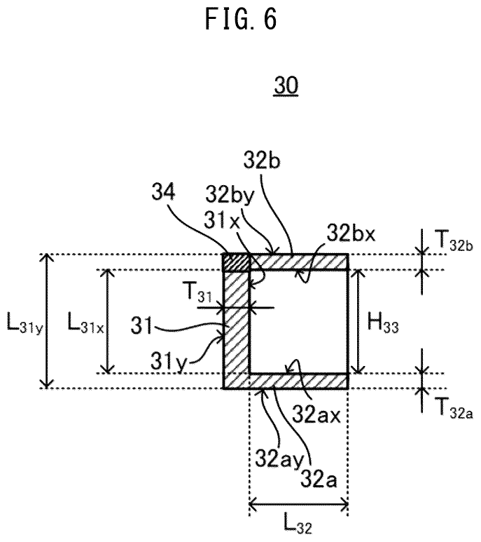

As shown in FIGS. 2, 3, and 5 to 8, the terminal 30 has a base 31, a first protrusion 32a, and a second protrusion 32b. As shown in FIGS. 2 and 3, the first surface 31x on the electrode laminate 10 side of the base 31 may face the inside of the battery and be connected to the current collector part 20, and the second surface 31y on the side opposite the electrode laminate 10 may face the outside of the battery 100. Further, as shown in FIG. 6, the third surface 32ax of the first protrusion 32a facing the second protrusion 32b may face the inside of the battery and may be connected to the current collector part 20. The first protrusion 32a may have a fifth surface 32ay on the side opposite the third surface 32ax, and the fifth surface 32ay may be adhered to the exterior body 40. As shown in FIG. 6, the fourth surface 32bx of the second protrusion 32b facing the first protrusion 32a may face the inside of the battery. The second protrusion 32b may have a sixth surface 32by on the side opposite the fourth surface 32bx, and the sixth surface 32by may be adhered to the exterior body 40.

### 1.3.1 Base

As shown in FIGS. 2, 3, and 5 to 8, the base 31 can have a first surface 31x facing the electrode laminate 10 and a second surface 31y on the side opposite the electrode laminate 10. The base 31 may correspond to, for example, the bottom of a vessel-shaped terminal 30. As shown in FIGS. 2 and 3, the first surface 31x may be in contact with the current collector part 20, and may have a joint 25 with the current collector part 20. The second surface 31y may face the outside of the battery 100. The first surface 31x and the second surface 31y of the base 31 may be, for example, flat surfaces as shown in the drawings, or may have concavities and convexities. The planar shapes of the first surface 31x and the second surface 31y (referring to the planar shape when the first surface and the second surface are projected) is not particularly limited. Though the planar shapes of the illustrated first surface 31x and second surface 31y are elongated rectangles, the planar shapes may be square, quadrangles other than rectangles (elongated rectangles and squares), other polygonal shapes, circles, ellipses, or other shapes. In particular, when the first surface 31x and second surface 31y are rectangular, and especially when they are elongated rectangles, case of handling and mechanical strength are likely to be improved. Note that the terms “polygon”, “quadrangle”, “rectangle”, and “elongated rectangle” in the present description each include concepts including shapes with chamfered corners and shapes with rounded corners.

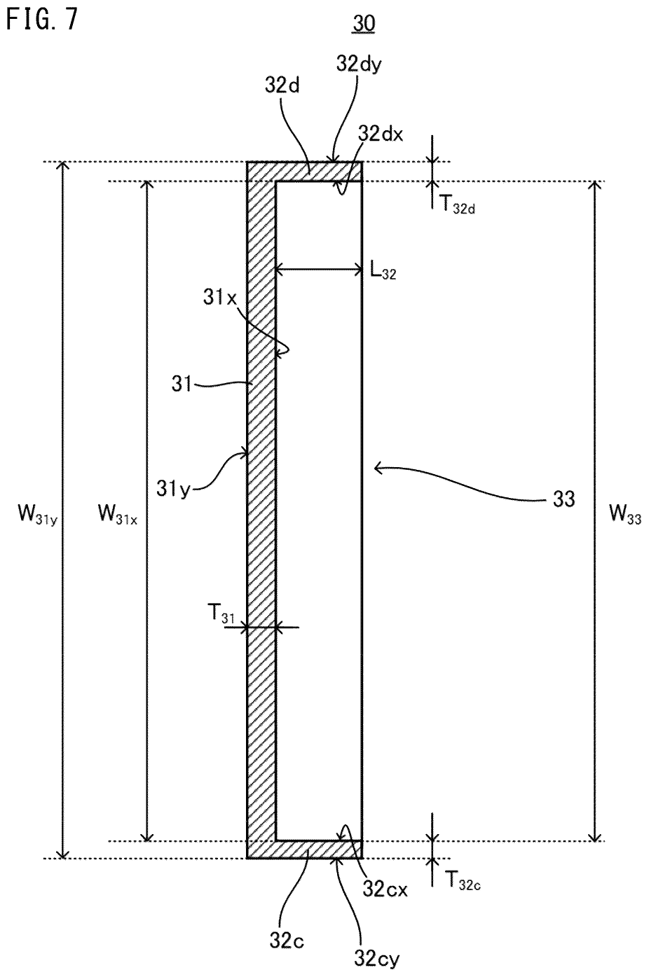

As shown in FIGS. 6 and 7, the base 31 can have a thickness T₃₁ (thickness from the first surface 31x to the second surface 31y). The thickness T₃₁ of the base 31 is not particularly limited. In particular, when the thickness T₃₁ of the base 31 is 0.1 mm or more and 10 mm or less or 0.2 mm or more and 3 mm or less, the structural efficiency around the terminal 30 and the strength of the terminal 30 tend to be well balanced.

As shown in FIG. 6, the base 31 can have a length (height) L₃₁ₓ along the lamination direction in the electrode laminate 10 in the inner dimension of the first surface 31x (from the inner surface of a third protrusion 32c to the inner surface of a fourth protrusion 32d). As shown in FIG. 6, the length L₃₁ₓ in the inner dimension of the first surface 31x of the base 31 may be the same as a height H₃₃ of an opening 33 of the terminal 30, which will be described later. Alternatively, the length L₃₁ₓ in the inner dimension of the first surface 31x of the base 31 may be smaller or larger than the height H₃₃. The length L₃₁ₓ in the inner dimension of the first surface 31x of the base 31 is not particularly limited, and may be 4.8 mm or more and 99.8 mm or less or 9.8 mm or more and 49.8 mm or less.

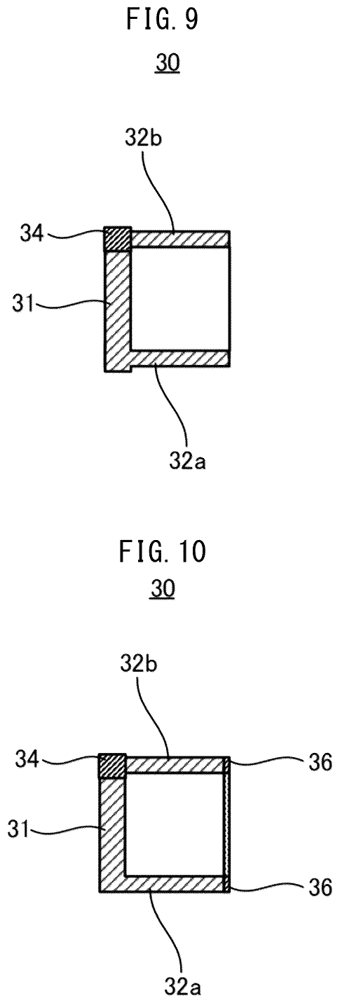

As shown in FIG. 6, the base 31 can have a length (height) L_{31y} at the second surface 31y along the lamination direction in the electrode laminate 10. As shown in FIG. 7, the length L_{31y} at the second surface 31y of the base 31 may be the same as a thickness T₃₀ of the terminal 30 (the length from the fifth surface 32ay of the first protrusion 32a to the sixth surface 32by of the second protrusion 32b). Alternatively, the length L_{31y} at the second surface 31y of the base 31 may be greater than the thickness T₃₀ of the terminal 30. Specifically, as shown in FIG. 9, the first protrusion 32a and the second protrusion 32b may protrude from inside the outer edge of the first surface 31x of the base 31 toward the electrode laminate 10. The length L_{31y} of the second surface 31y of the base 31 may be larger than L₃₁ₓ described above, may be smaller than T₁₀ described above, and may be, for example, 4.9 mm or more and 99.9 mm or less or 9.9 mm or more and 49.9 mm or less.

As shown in FIG. 7, the base 31 can have a width W₃₁ₓ along the lamination surface of the electrode laminate 10 in the inner dimension of the first surface 31x. As shown in FIG. 7, the width W₃₁ₓ in the inner dimension of the first surface 31x of the base 31 may be the same as the width W₃₃ of the opening 33 of the terminal 30, which will be described later. Alternatively, the width W₃₁ₓ in the inner dimension of the first surface 31x of the base 31 may be smaller than the width W₃₃. The width W₃₁ₓ in the inner dimension of the first surface 31x of the base 31 may be larger than W₂₀ described above, may be smaller than W_{31y}, which will be described later, and may be smaller than W₁₀ described above. W₃₁ₓ may be, for example, 7.5 mm or more and 475 mm or less or 30 mm or more and 195 mm or less.

As shown in FIG. 7, the base 31 can have a width W_{31y} at the second surface 31y along the lamination surface of the electrode laminate 10. As shown in FIG. 7, the width W_{31y} of the second surface 31y of the base 31 may be the same as the sum of the width W₃₃ of the opening 33, the thickness T_{32c} of the third protrusion 32c, and the thickness T_{32d} of the fourth protrusion 32d, of the terminal 30, which will be described later. Alternatively, the width W_{31y} of the second surface 31y of the base 31 may be larger than the sum of the width W₃₃, the thickness T_{32c}, and the thickness T_{32d}. The width W_{31y} of the second surface 31y of the base 31 may be larger than W₂₀ described above, may be larger than W₃₁ₓ described above, may be larger than W₃₃ described above, and may be smaller than W₁₀ described above. W_{31y} may be, for example, 8.1 mm or more and 475.1 mm or less or 30.1 mm or more and 195.1 mm or less.

The ratio L₃₁ₓ/W₃₁ₓ of the length (height) L₃₁ₓ to the width W₃₁ₓ of the first surface 31x of the base 31 is not particularly limited. In particular, when the ratio L₃₁ₓ/W₃₁ₓ is 0.01 or more and 13.3 or less or 0.05 or more and 1.66 or less, the connectivity of the current collector part 20 to the terminal 30 and the strength of the terminal are easily secured.

The ratio L_{31y}/W_{31y} of the length (height) L_{31y} to the width W_{31y} of the second surface 31y of the base 31 is not particularly limited. In particular, when the ratio L_{31y}/W_{31y} is 0.01 or more and 13.3 or less or 0.05 or more and 1.66 or less, the connectivity of the current collector part 20 to the terminal 30 and the strength of the terminal are easily secured.

### 1.3.2 Protrusion

The protrusion 32 protrudes from the base 31 toward the electrode laminate 10. As shown in FIGS. 2, 3, and 5 to 8, the protrusion 32 may protrude linearly from the base 31 toward the electrode laminate 10 while having a thickness. As shown in FIG. 2, the protrusion 32 comprises a first protrusion 32a and a second protrusion 32b in one cross section. The first protrusion 32a has a third surface 32ax facing the second protrusion 32b. The first protrusion 32a may have a fifth surface 32ay opposite the third surface 32ax. The second protrusion 32b has a fourth surface 32bx facing the first protrusion 32a. The second protrusion 32b may have a sixth surface 32by opposite the fourth surface 32bx. Furthermore, as shown in FIG. 3, the protrusion 32 may have a third protrusion 32c and a fourth protrusion 32d in a cross section perpendicular to the one cross section. In this case, the third protrusion 32c may have a seventh surface 32cx facing the fourth protrusion 32d and an eighth surface 32cy opposite the seventh surface 32cx. The fourth protrusion 32d may have a ninth surface 32dx facing the third protrusion 32c and a tenth surface 32dy opposite the ninth surface 32dx.

In the battery 100, the thickness T₃₂ of the protrusion 32 (for example, T₃₂ₐ to T_{32d} in FIGS. 6 to 8) is not particularly limited, and may be 0.1 mm or more and 10 mm or less or 0.2 mm or more and 3 mm or less. Note that the “thickness of the protrusion” in the present description is measured at the end surface of the protrusion on the electrode laminate side.

As shown in FIGS. 6 and 7, the protrusion 32 can have a protrusion length L₃₂ from the first surface 31x of the base 31 toward the electrode laminate 10. The protrusion length L₃₂ of the protrusion 32 is not particularly limited and may be 3 mm or more and 50 mm or less or 5 mm or more and 30 mm or less. The protrusion 32 may have the same protrusion length L₃₂ as a whole. Specifically, the first protrusion 32a, the second protrusion 32b, the third protrusion 32c, and the fourth protrusion 32d may be flush with each other at the end surfaces on the electrode laminate 10 side. Alternatively, the protrusion length of a part of the protrusion 32 may be different from the protrusion length of the other parts of the protrusion 32.

As shown in FIGS. 6 and 7, the thickness T₃₁ of the base 31 may be smaller than the protrusion length L₃₂ of the protrusion 32. By making the thickness T₃₁ of the base 31 relatively thin, the space for inserting the current collector part 20 is increased. The ratio T₃₁/L₃₂ of the thickness T₃₁ of the base 31 to the protrusion length L₃₂ of the protrusion 32 may be, for example, more than 0 and less than 1.0, 0.02 or more and 0.50 or less, or 0.05 or more and 0.25 or less.

As shown in FIGS. 2, 3, and 5 to 8, in the terminal 30, the protrusion 32 may protrude from the outer edge of the base 31. Specifically, the planar shape of the second surface 31y of the base 31 may coincide with the shape defined by the outer periphery of the protrusion 32. Alternatively, as shown in FIG. 9, the protrusion 32 may protrude from inside the outer edge of the first surface 31x of the base 31. Specifically, the planar shape of the second surface 31y of the base 31 may be larger than the shape defined by the outer periphery of the protrusion 32.

When the protrusion 32 protrudes from the outer edge of the base 31, the shape defined by the outer periphery of the protrusion 32 corresponds to the planar shape of the second surface 31y of the base 31. For example, when the planar shape of the base 31 (planar shape of the second surface 31y) is rectangular and the rectangle has a first side and a second side facing each other and a third side and a fourth side facing each other, the first protrusion 32a may protrude from the first side, the second protrusion 32b may protrude from the second side, the third protrusion 32c may protrude from the third side, and the fourth protrusion 32d may protrude from the fourth side. By adopting a configuration in which the protrusion 32 protrudes from the outer edge of the rectangular base 31 in this manner, the structural efficiency around the terminal and the strength of the terminal can easily be secured.

For example, when the planar shape of the base 31 (planar shape of the second surface 31y) is an elongated rectangle, the first protrusion 32a may protrude from one long side of the elongated rectangle, the second protrusion 32b may protrude from the other long side of the elongated rectangle, the third protrusion 32c may protrude from one short side of the elongated rectangle, and the fourth protrusion 32d may protrude from the other short side of the elongated rectangle. Since the protrusion 32 protrudes from the outer edge of the elongated rectangular base 31 in this manner, the structural efficiency around the terminal and the strength of the terminal can easily be secured. Furthermore, by forming a weld 34 on at least the long side of the base 31, the strength of the terminal 30 can easily be further improved.

Furthermore, when the planar shape of the base 31 (planar shape of the second surface 31y) is an elongated rectangle, the lamination direction in the electrode laminate 10 may be along the short sides of the elongated rectangle, and the width direction of the electrode laminate 10 may be along the long sides of the elongated rectangle. As a result, a large space for inserting the current collector part 20 can easily be secured, and an excellent balance of structural efficiency and strength around the terminal 30 and the current collector part 20 can easily be achieved.

### 1.3.2.1 First Protrusion

The first protrusion 32a has a third surface 32ax facing the second protrusion 32b and a fifth surface 32ay opposite the third surface 32ax. As shown in FIG. 2, the third surface 32ax may contact the current collector part 20. The third surface 32ax may have a joint with the current collector part 20. Conversely, as shown in FIG. 2, the fifth surface 32ay may be an adhesive surface with the exterior body 40. The third surface 32ax and the fifth surface 32ay of the first protrusion 32a may be flat as shown in the drawing, or may have concavities and convexities. The planar shapes of the third surface 32ax and the fifth surface 32ay (referring to the planar shapes when the third surface and the fifth surface are projected) are not particularly limited. In particular, when the third surface 32ax and the fifth surface 32ay have rectangular planar shapes, the structural efficiency around the terminal 30 is likely to be improved, and the connectivity of the current collector part 20 to the terminal 30 and the strength of the terminal 30 are likely to be improved.

### 1.3.2.2 Second Protrusion

The second protrusion 32b has a fourth surface 32bx facing the first protrusion 32a and a sixth surface 32by opposite the fourth surface 32bx. As shown in FIG. 2, the fourth surface 32bx need not contact the current collector part 20. Conversely, as shown in FIG. 2, the sixth surface 32by may be an adhesive surface with the exterior body 40. The fourth surface 32bx and the sixth surface 32by of the second protrusion 32b may be, for example, flat surfaces as shown in the drawing, or may have concavities and convexities. The planar shapes of the fourth surface 32bx and the sixth surface 32by (referring to the planar shapes when the fourth surface and the sixth surface are projected) are not particularly limited. In particular, when the fourth surface 32bx and the sixth surface 32by have rectangular planar shapes, the structural efficiency around the terminal 30 is likely to be improved, and the connectivity of the current collector part 20 to the terminal 30 and the strength of the terminal 30 are likely to be improved.

### 1.3.2.3 Third Protrusion

The third protrusion 32c may have a seventh surface 32cx facing the fourth protrusion 32d and an eighth surface 32cy opposite the seventh surface 32cx. As shown in FIG. 3, the seventh surface 32cx need not contact the current collector part 20. Conversely, as shown in FIG. 3, the eighth surface 32cy may be an adhesive surface with the exterior body 40. The seventh surface 32cx and the eighth surface 32cy of the third protrusion 32c may be, for example, flat surfaces as shown in the drawing, or may have concavities and convexities. The planar shapes of the seventh surface 32cx and the eighth surface 32cy (referring to the planar shapes when the seventh surface and the eighth surface are projected) are not particularly limited. In particular, when the seventh surface 32cx and the eighth surface 32cy have rectangular planar shapes, the structural efficiency around the terminal 30 is likely to be improved, and the connectivity of the current collector part 20 to the terminal 30 and the strength of the terminal 30 are likely to be improved.

### 1.3.2.4 Fourth Protrusion

The fourth protrusion 32d may have a ninth surface 32dx facing the third protrusion 32c and a tenth surface 32dy opposite the ninth surface 32dx. As shown in FIG. 3, the ninth surface 32dx need not contact the current collector part 20. Conversely, as shown in FIG. 3, the tenth surface 32dy may be an adhesive surface with the exterior body 40. The ninth surface 32dx and the tenth surface 32dy of the fourth protrusion 32d may be, for example, a flat surface as shown in the drawing, or may have concavities and convexities. The planar shapes of the ninth surface 32dx and the tenth surface 32dy (referring to the planar shapes when the seventh surface and the eighth surface are projected) are not particularly limited. In particular, when the ninth surface 32dx and the tenth surface 32dy have rectangular planar shapes, the structural efficiency around the terminal 30 is likely to be improved, and the connectivity of the current collector part 20 to the terminal 30 and the strength of the terminal 30 are likely to be improved.

### 1.3.3 Opening

As shown in FIGS. 2, 3, and 5 to 7, the terminal 30 may have an opening 33 on the electrode laminate 10 side. In this case, the current collector part 20 can be inserted into the opening 33 and connected to the terminal 30. The shape of the opening 33 can be defined in accordance with the protrusion 32. The shape of the opening 33 is not particularly limited. The shape of the opening 33 may be rectangular, circular, or elliptical, or may be another shape.

When the shape of the opening 33 is rectangular and the rectangle has a first side and a second side facing each other and a third side and a fourth side facing each other, the first protrusion 32a of the protrusion 32 may constitute the first side, the second protrusion 32b may constitute the second side, the third protrusion 32c may constitute the third side, and the fourth protrusion 32d may constitute the fourth side. When the shape of the opening 33 defined by the protrusion 32 is rectangular, it becomes easier to ensure the structural efficiency around the terminal and the strength of the terminal.

When the shape of the opening 33 is an elongated rectangle, the first protrusion 32a of the protrusion 32 may constitute one short side of the elongated rectangle, the second protrusion 32b may constitute the other short side of the elongated rectangle, the third protrusion 32c may constitute one long side of the elongated rectangle, and the fourth protrusion 32d may constitute the other long side of the elongated rectangle. In this case as well, the structural efficiency around the terminal and the strength of the terminal are easily secured. Furthermore, since the second protrusion 32b welded to the base 31 constitutes a long side of the elongated rectangle, the strength of the terminal 30 can easily be further improved.

When the shape of the opening 33 is an elongated rectangle, the lamination direction in the electrode laminate 10 may be along the short sides of the elongated rectangle, and the width direction of the electrode laminate 10 may be along the long sides of the elongated rectangle. As a result, a large space for inserting the current collector part 20 can easily be secured, and an excellent balance of structural efficiency and strength around the terminal 30 and the current collector part 20 can easily be achieved.

As shown in FIG. 6, the opening 33 can have a height H₃₃ along the lamination direction in the electrode laminate 10. The height H₃₃ of the opening 33 is not particularly limited. In particular, when the height H₃₃ of the opening 33 is 4.8 mm or more and 99.8 mm or less, or 9.8 mm or more and 49.8 mm or less, the strength of the terminal 30 is easily secured, and the current collector part 20 can more easily be inserted into the opening 33 and joined to the terminal 30.

As shown in FIG. 6, the opening 33 can have a width W₃₃ along the lamination surface of the electrode laminate 10. The width W₃₃ of the opening 33 is not particularly limited. In particular, when the width W₃₃ of the opening 33 is 7.5 mm or more and 475 mm or less, or 30 mm or more and 195 mm or less, the strength of the terminal 30 is easily secured, and the width W₂₀ of the current collector part 20 is easily secured sufficiently.

The ratio H₃₃/W₃₃ of the height H₃₃ to the width W₃₃ of the opening 33 is not particularly limited. In particular, when the ratio H₃₃/W₃₃ is 0.01 or more and 13.3 or less, or 0.05 or more and 1.66 or less, the joinability of the current collector part 20 and the strength of the terminal 30 are likely to be excellent.

### 1.3.4 Other Features Regarding Terminal

As described above, the base 31 can have a thickness T₃₁, and the protrusion 32 can have a thickness T₃₂. The relationship between the thickness T₃₁ of the base 31 and the thicknesses T₃₂ₐ and T_{32b} of the first protrusion 32a and second protrusion 32b is not particularly limited. In particular, when the base 31 is thicker than the first protrusion 32a and second protrusion 32b, the structural efficiency around the terminal and the strength of the terminal are likely to be improved.

The relationship of the thickness T₃₁ of the base 31 with the thicknesses T_{32c} and T_{32d} of the third protrusion 32c and fourth protrusion 32d is not particularly limited. In particular, when the base 31 is thicker than the third protrusion 32c and fourth protrusion 32d, the structural efficiency around the terminal and the strength of the terminal are likely to be improved.

As described above, in the battery 100, the second protrusion 32b is welded to the base 31 of the terminal 30. When a part of the protrusion 32 is welded to the base 31 in this manner, design freedom for the space for connecting the current collector part 20 in the terminal 30 is increased, and the current collector part 20 can be easily connected to the terminal 30 by, for example, connecting the current collector part 20 to the base 31 and/or the first protrusion 32a and then welding the second protrusion 32b so as to cover the terminal 30. Furthermore, by welding a part of the protrusion 32 to the base 31, a weld 34 is formed in the terminal 30, whereby the strength of the terminal 30 can be improved by the weld 34. Though only the second protrusion 32b of the protrusion 32 is welded in the illustrated embodiment, the aspect of the terminal 30 is not limited thereto. For example, one or both of the third protrusion 32c and the fourth protrusion 32d may be welded to at least one of the base 31, the first protrusion 32a, and the second protrusion 32b. When one or both of the third protrusion 32c and the fourth protrusion 32d are welded in this manner, the effects described above can be expected.

The terminal 30 including the base 31 and the protrusion 32 (as well as the opening 33) can be produced by, for example, press molding a metal to obtain a first metal member comprising the base 31 and the first protrusion 32a, and then welding a second metal member serving as the second protrusion 32b to the first metal member. For example, the base 31, the first protrusion 32a, the third protrusion 32c, and the fourth protrusion 32d may be formed by applying pressure to one surface of a first metal member having a predetermined shape (for example, a rectangular parallelepiped) to form concavities and convexities, and a second metal member having a predetermined shape (for example, a plate-like shape) may then be welded to the first metal member to form the second protrusion 32b. Alternatively, the terminal 30 may be formed by welding a second metal member corresponding to the second protrusion 32b, a third metal member corresponding to the third protrusion 32c, and a fourth metal member corresponding to the fourth protrusion 32d to the first metal member on which the base 31 and the first protrusion 32a have been formed by press molding or the like.

The material of the terminal 30 may be appropriately selected taking into consideration sufficient electrical conductivity, appropriate heat capacity, appropriate mechanical strength, etc. For example, the material of the terminal 30 may be aluminum, copper, iron, nickel, or an alloy thereof.

An insulating layer may be provided between the terminal 30 and the electrode laminate 10. As a result, short circuits in the battery 100 can more easily be suppressed. For example, as shown in FIG. 10, the protrusion 32 of the terminal 30 may have an insulating layer 36 on the end surface on the electrode laminate 10 side. For example, the insulating layer 36 can be formed on the end surface by applying or transferring an insulating resin material (for example, an ultraviolet-curing resin such as acrylic monomer/oligomer; thermosetting resin such as epoxy resin or imide resin; or thermoplastic resin such as polypropylene or polyethylene) to the end surface of the protrusion 32 of the terminal 30, or by forming a layer composed of a metal oxide (for example, aluminum oxide) on the end surface by anodization or the like. The thickness of the insulating layer 36 is not particularly limited. When the insulating layer 36 is composed of an insulating resin material, the thickness may be, for example, 0.1 mm or more and 1.0 mm or less. Furthermore, when the insulating layer 36 is composed of a metal oxide formed by anodization or the like, the thickness thereof may be, for example, 0.01 mm or more and less than 0.10 mm.

### 1.4 Supplementary Information Regarding Arrangement of Electrode Laminate, Current Collector Part, and Terminal

In the battery 100, the arrangement of the electrode laminate 10, the current collector part 20, and the terminal 30 is not particularly limited as long as the current collector part 20 protruding from the electrode laminate 10 is electrically connected to a predetermined surface of the terminal 30. Since a terminal 30 having the specific shape described above is adopted in the battery 100, space around the terminal 30 and the current collector part 20 can easily be saved, and the connectivity of the current collector part 20 to the terminal 30 can easily be improved. An example of the arrangement of the electrode laminate 10, the current collector part 20, and the terminal 30 will be supplemented below.

### 1.4.1 Width of Terminal and Width of Current Collector Part

As described above, the current collector part 20 protruding from the electrode laminate 10 may be inserted into the opening 33 of the terminal 30 and connected to a predetermined surface of the terminal 30. When a large current flows through the current collector part 20 and the terminal 30, heat can be generated in the current collector part 20 and the terminal 30. According to the knowledge of the present inventors, the heat generation temperature around the terminal 30 and the current collector part 20 varies depending on the width of the current collector part 20 relative to the width of the terminal 30. As shown in FIG. 3, for example, when the ratio W₂₀/W₃₃ of the width W₂₀ of the current collector part 20 to the width W₃₃ of the opening 33 of the terminal 30 is 0.9 or more, the heat generation around the terminal 30 and the current collector part 20 can be suppressed particularly remarkably. Alternatively, when the ratio W₂₀/W₃₁ₓ of the width W₂₀ of the current collector part 20 to the inner width W₃₁ₓ of the base 31 of the terminal 30 (the width at the inner dimension of the first surface 31x) is 0.9 or more, heat generation around the terminal 30 and the current collector part 20 can be suppressed particularly remarkably.

### 1.4.2 Thickness of Electrode Laminate and Thickness of Terminal

The thickness T₃₀ of the terminal 30 may be thicker than, equal to, or thinner than the thickness T₁₀ of the electrode laminate 10. In particular, as shown in FIG. 2, when the thickness T₃₀ of the terminal 30 is thinner than the thickness of the electrode laminate 10, it becomes easier to further improve the adhesion between the exterior body and the terminal 30 by, for example, arranging a resin 35 between the laminate exterior body and the terminal 30.

### 1.4.3 Joint Form Between Current Collector Part and Terminal

As described above, the current collector part 20 is connected to the terminal 30. For example, the current collector part 20 may be joined to the first surface 31x and/or the third surface 32ax of the terminal 30 to form a joint 25. In an embodiment, the current collector part 20 may be ultrasonically joined or laser joined to one or both of the first surface 31x and the third surface 32ax.

### 1.5 Other Members

The battery 100 can have obvious structures as a battery in addition to the above-mentioned electrode laminate 10, current collector part 20, and terminal 30. For example, various members such as those disclosed in Patent Literature 1 (Japanese Unexamined Patent Publication (Kokai) No. 2023-084066) can be adopted as other members. Examples of other members provided in the battery 100 will be described below.

### 1.5.1 Exterior Body

The battery 100 can comprise an exterior body 40 for housing the electrode laminate 10 and the current collector part 20. The exterior body may be a laminate exterior body composed of a laminate film or may be composed of a metal case. As shown in the drawings, the first protrusion 32a may have the third surface 32ax and the fifth surface 32ay opposite thereto, the second protrusion 32b may have the fourth surface 32bx and the sixth surface 32by opposite thereto, the electrode laminate 10 and the current collector part 20 may be housed in a laminate exterior body, and the laminate exterior body may be adhered to the fifth surface 32ay of the first protrusion 32a and the sixth surface 32by of the second protrusion 32b.

The exterior body 40 may be, for example, a cylindrical body having an opening. Specifically, as shown in FIGS. 2 and 3, the electrode laminate 10 and the current collector part 20 can be housed inside the cylindrical exterior body 40, and the outer surface of the protrusion 32 of the terminal 30 can be adhered and sealed to the vicinity of the opening of the exterior body 40. In this case, as shown in FIGS. 2 and 3, the vicinity of the opening of the exterior body 40 and the protrusion 32 of the terminal 30 can be adhered to each other so as to overlap each other when viewed in the lamination direction in the electrode laminate 10. This can improve the structural efficiency around the terminal 30 while increasing the sealing performance of the battery 100.

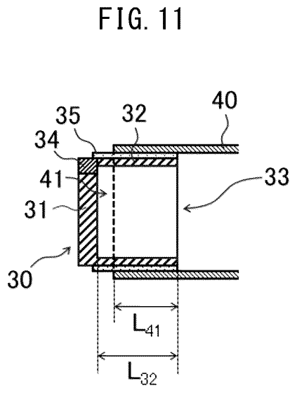

As shown in FIG. 11, the length L₄₁ between the end surface (or opening 33) of the protrusion 32 of the terminal 30 and the opening 41 of the exterior body 40 is not particularly limited. In particular, when the length L₄₁ is 1.0 mm or more and 20 mm or less, or 3.0 mm or more and 15 mm or less, the balance between the sealing performance and the structural efficiency is likely to be suitable. Furthermore, the ratio L₄₁/L₃₂ of the length L₄₁ to the protrusion length L₃₂ of the protrusion 32 is not particularly limited. In particular, when the ratio L₄₁/L₃₂ is 0.1 or more and 1.0 or less, or 0.5 or more and 1.0 or less, the balance between the sealing performance and the structural efficiency is likely to be suitable. When the exterior body 40 is a laminate exterior body, the laminate exterior body may be adhered to the outer surface of the protrusion 32 by heat sealing or the like, for example. Furthermore, when the exterior body 40 is a metal case, the metal case can be adhered to the outer circumferential surface of the protrusion 32 by, for example, welding or using an adhesive. As described above, the resin 35 may be arranged between the outer surface of the protrusion 32 and the exterior body 40.

### 1.5.2 Busbar

The battery 100 may comprise a conductive member for connecting one battery to another. For example, in the battery 100, a busbar may be connected to the terminal 30. A plurality of batteries 100 may be combined to form a battery assembly.

### 1.6 Applications

There are many applications for the battery 100. For example, the battery 100 can be suitably used in at least one type of vehicle selected from a hybrid electric vehicle (HEV), a plug-in hybrid electric vehicle (PHEV), and a battery electric vehicle (BEV). Specifically, an aspect of the technology of the present disclosure relates to a vehicle having a battery 100, the battery 100 having an electrode laminate 10, a current collector part 20, and a terminal 30, the electrode laminate 10 being electrically connected to the terminal 30 via the current collector part 20, the terminal 30 having a base 31 and a protrusion 32, the base 31 having a first surface 31x facing the electrode laminate 10 and a second surface 31y opposite the first surface 31x, the protrusion 32 protruding from the base 31 toward the electrode laminate 10, the protrusion 32 having a first protrusion 32a and a second protrusion 32b, the first protrusion 32a having a third surface 32ax facing the second protrusion 32b, and a fifth surface 32ay opposite the third surface 32ax, the second protrusion 32b having a fourth surface 32bx facing the first protrusion 32a, and a sixth surface 32by opposite the fourth surface 32bx, the current collector part 20 being in contact with one or both of the first surface 31x and the third surface 32ax, and the second protrusion 32b being welded to the base 31.

### 2. Battery Production Method

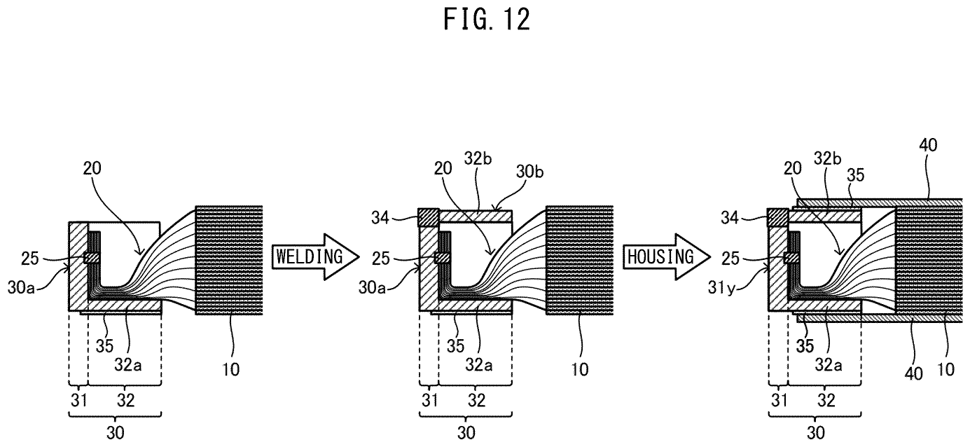

The battery 100 can be produced, for example, as described below. Specifically, as shown in FIG. 12, the production method for the battery 100 may comprise connecting the current collector part 20 to the first metal member 30a, and welding the second metal member 30b to the first metal member 30a to which the current collector part 20 is connected. In this case, the base 31 and the first protrusion 32a of the terminal 30 may be constituted by the first metal member 30a, and the second protrusion 32b of the terminal 30 may be constituted by the second metal member 30b. Since the current collector part 20 is connected to the first metal member 30a and the second metal member 30b is then welded thereto in this manner, connectivity of the current collector part 20 to the terminal 30 can be improved. As shown in FIG. 12, after welding the second metal member 30b, the electrode laminate 10 and the current collector part 20 may be housed inside the exterior body 40 while exposing a part (second surface 31y) of the terminal 30 to the outside of the exterior body 40.

Note that the electrode laminate 10 and the current collector part 20 may be produced by a known method. A known connection method may be adopted for the connecting the current collector part 20 to the first metal member 30a. For example, ultrasonic bonding or laser bonding as described above may be adopted. The method for welding the second metal member 30b to the first metal member 30a is not particularly limited. An appropriate welding method with which the metal members can be joined together may be appropriately selected. The method of housing and sealing the electrode laminate 10 in the exterior body 40 is not particularly limited. As described above, known methods such as heat sealing the laminate exterior body can be adopted.

### REFERENCE SIGNS LIST

100 battery
10 electrode laminate
20 current collector part
25 joint
30 terminal
31 base
31x first surface
31y second surface
32 protrusion
32a first protrusion
32ax third surface
32ay fifth surface
32b second protrusion
32bx fourth surface
32by sixth surface
32c third protrusion
32cx seventh surface
32cy eighth surface
32d fourth protrusion
32dx ninth surface
32dy tenth surface
33 opening
34 weld
35 resin
36 insulating layer
40 exterior body
41 opening

1. A battery, comprising an electrode laminate, a current collector part, and a terminal, wherein
the electrode laminate is electrically connected to the terminal via the current collector part,
the terminal comprises a base and a protrusion,
the base has a first surface facing the electrode laminate and a second surface opposite the first surface,
the protrusion protrudes from the base toward the electrode laminate,
the protrusion comprises a first protrusion and a second protrusion,
the first protrusion has a third surface facing the second protrusion,
the second protrusion has a fourth surface facing the first protrusion,
the current collector part is in contact with one or both of the first surface and the third surface, and
the second protrusion is welded to the base.

2. The battery according to claim 1, wherein
the base is thicker than the first protrusion and the second protrusion.

3. The battery according to claim 1, wherein
the protrusion comprises a third protrusion and a fourth protrusion.

4. The battery according to claim 3, wherein
the base is thicker than the third protrusion and the fourth protrusion.

5. The battery according to claim 3, wherein
one or both of the third protrusion and the fourth protrusion is welded to at least one of the base, the first protrusion, and the second protrusion.

6. The battery according to claim 3, wherein
a planar shape of the base is a rectangle,
the rectangle comprises a first side and a second side facing each other and a third side and a fourth side facing each other,
the first protrusion protrudes from the first side,
the second protrusion protrudes from the second side,
the third protrusion protrudes from the third side, and
the fourth protrusion protrudes from the fourth side.

7. The battery according to claim 3, wherein
a planar shape of the base is an elongated rectangle,
the first protrusion protrudes from one long side of the elongated rectangle,
the second protrusion protrudes from another long side of the elongated rectangle,
the third protrusion protrudes from one short side of the elongated rectangle, and
the fourth protrusion protrudes from another short side of the elongated rectangle.

8. The battery according to claim 7, wherein
a lamination direction in the electrode laminate is along the short sides, and
a width direction of the electrode laminate is along the long sides.

9. The battery according to claim 1, wherein
the protrusion protrudes from an outer edge of the base.

10. The battery according to claim 1, wherein
a ratio of a width of the current collector part to an inner width of the base is 0.9 or more.

11. The battery according to claim 1, wherein
a thickness of the base is less than a protrusion length of the protrusion.

12. The battery according to claim 1, wherein
a thickness of the terminal is less than a thickness of the electrode laminate.

13. The battery according to claim 1, wherein
the terminal is connected to a bus bar.

14. The battery according to claim 1, wherein
the current collector part is ultrasonically or laser joined to one or both of the first surface and the third surface.

15. The battery according to claim 1, wherein
the protrusion has an insulating layer at an end surface on the electrode laminate side.

16. The battery according to claim 1, wherein
the first protrusion has a fifth surface opposite the third surface,
the second protrusion has a sixth surface opposite the fourth surface,
the electrode laminate and the current collector part are housed in a laminate exterior body, and
the laminate exterior body is adhered to the fifth surface and the sixth surface.

17. A method for the production of the battery according to claim 1, the method comprising:
connecting the current collector part to a first metal member, and
welding a second metal member to the first metal member, to which the current collector part is connected, wherein
the base and the first protrusion of the terminal are constituted by the first metal member, and
the second protrusion of the terminal is constituted by the second metal member.
